(19) United States
(12) Patent Application Publication
(10) Pub. No.: US 2022/0337472 A1
(43) Pub. Date: Oct. 20, 2022

(54) BEAM FAILURE RECOVERY FOR SERVING CELL

(71) Applicant: NOKIA TECHNOLOGIES OY, Espoo (FI)

(72) Inventors: Samuli TURTINEN, Ii (FI); Timo KOSKELA, Oulu (FI); Chunli WU, Beijing (CN)

(21) Appl. No.: 17/764,441

(22) PCT Filed: Sep. 30, 2019
(86) PCT No.: PCT/CN2019/109500

§ 371 Date: Mar. 28, 2022

(51) Int. Cl. H04L 41/0654; H04L 5/00; H04L 41/0681; H04B 7/0408

(52) U.S. Cl. CPC H04L 41/0654; H04L 5/0048; H04L 41/0681; H04B 7/0408

(57) ABSTRACT

A method of beam failure recovery for a serving cell is disclosed. In response to a beam failure on a first bandwidth part in a serving cell, a first device detects a first candidate beam associated with the first bandwidth part (310). In response to a failure of detecting the first candidate beam, the first device switches from the first bandwidth part to a second bandwidth part in the serving cell. The second bandwidth part is configured with at least one reference signal identifying a second candidate beam for recovery from the beam failure (320). The first device detects the second candidate beam based on the at least one reference signal (330). In response to a success of detecting the second candidate beam, the first device transmits information concerning the second candidate beam to a second device for the recovery from the beam failure (340).

### FIELD

Embodiments of the present disclosure generally relate to the field of telecommunication and in particular, to methods, devices, apparatuses and computer readable storage media for beam failure recovery (BFR) for a serving cell.

### BACKGROUND

New radio access system, which is also called NR system or NR network, is the next generation communication system. It has been agreed that carrier aggregation (CA) which is used in Long Term Evolution (LTE)-Advanced to increase the bandwidth will be supported in the NR system. When CA is used, there are a number of serving cells. Generally, the serving cells may include a primary cell (PCell) and at least one secondary cell (SCell). A beam failure may occur when the quality of beam pair(s) of a serving cell falls low enough (for example, comparison with a threshold or time-out of an associated timer).

A BFR procedure is a mechanism for recovering beams when all or part of beams serving a terminal device has failed. Beam recovery may be also referred to as link reconfiguration. Aim of the beam recovery is to detect when one or more physical downlink control channels (PDCCH) links are considered to be in failure conditions and recover the link. To recover the link, the terminal device initiates signaling towards a network device to indicate failure and a new potential link. The new potential link may be referred to as a candidate beam. As a response to beam failure recovery request (BFRR) received from the terminal device, the network device may configure the terminal device with a new PDCCH link. Currently, the beam failure recovery has been defined for one serving cell, which in practice covers beam failure recovery for PCell only. Thus, there still remains a need to provide a solution for beam failure recovery especially for SCell.

### SUMMARY

In general, example embodiments of the present disclosure provide a solution for beam failure recovery for a serving cell.

In a first aspect, there is provided a first device. The first device comprises at least one processor; and at least one memory including computer program codes; the at least one memory and the computer program codes are configured to, with the at least one processor, cause the first device to: in response to a beam failure in a serving cell, detect a first candidate beam associated with a first bandwidth part, the first bandwidth part being active; in response to a failure of detecting the first candidate beam, switch from the first bandwidth part to a second bandwidth part in the serving cell, the second bandwidth part configured with at least one reference signal identifying a second candidate beam for recovery from the beam failure; detect the second candidate beam based on the at least one reference signal; and in response to a success of detecting the second candidate beam, transmit information concerning the second candidate beam to a second device for the recovery from the beam failure.

In a second aspect, there is provided a second device. The second device comprises at least one processor; and at least one memory including computer program codes; the at least one memory and the computer program codes are configured to, with the at least one processor, cause the second device to: in response to a success of detecting, by a first device, a second candidate beam associated with a second bandwidth part in a serving cell, receive information concerning the second candidate beam from the first device, the second bandwidth part configured with at least one reference signal identifying the second candidate beam for recovery from a beam failure in the serving cell, the second device operating in a first bandwidth part that is active; and communicate with the first device by using the second candidate beam.

In a third aspect, there is provided a method. The method comprises: in response to a beam failure in a serving cell, detecting, at a first device, a first candidate beam associated with a first bandwidth part, the first bandwidth part being active; in response to a failure of detecting the first candidate beam, switching from the first bandwidth part to a second bandwidth part in the serving cell, the second bandwidth part configured with at least one reference signal identifying a second candidate beam for recovery from the beam failure; detecting the second candidate beam based on the at least one reference signal; and in response to a success of detecting the second candidate beam, transmitting information concerning the second candidate beam to a second device for the recovery from the beam failure.

In a fourth aspect, there is provided a method. The method comprises: in response to a success of detecting, by a first device, a second candidate beam associated with a second bandwidth part in a serving cell, receiving, at a second device and from the first device, information concerning the second candidate beam, the second bandwidth part configured with at least one reference signal identifying the second candidate beam for recovery from a beam failure in the serving cell, the second device operating in a first bandwidth part that is active; and communicating with the first device by using the second candidate beam.

In a fifth aspect, there is provided an apparatus. The apparatus comprises: in response to a beam failure in a serving cell, means for detecting, at a first device, a first candidate beam associated with a first bandwidth part, the first bandwidth part being active; in response to a failure of detecting the first candidate beam, means for switching from the first bandwidth part to a second bandwidth part in the serving cell, the second bandwidth part configured with at least one reference signal identifying a second candidate beam for recovery from the beam failure; means for detecting the second candidate beam based on the at least one reference signal; and in response to a success of detecting the second candidate beam, means for transmitting information concerning the second candidate beam to a second device for the recovery from the beam failure.

In a sixth aspect, there is provided an apparatus. The apparatus comprises: in response to a success of detecting, by a first device, a second candidate beam associated with a second bandwidth part in a serving cell, means for receiving, at a second device and from the first device, information concerning the second candidate beam, the second bandwidth part configured with at least one reference signal identifying the second candidate beam for recovery from a beam failure in the serving cell, the second device operating in a first bandwidth part that is active; and means for communicating with the first device by using the second candidate beam.

In a seventh aspect, there is provided a computer readable medium comprising a computer program for causing an apparatus to perform at least the method according to the above third aspect.

In an eighth aspect, there is provided a computer readable medium comprising a computer program for causing an apparatus to perform at least the method according to the above fourth aspect.

It is to be understood that the summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Some example embodiments will now be described with reference to the accompanying drawings, where:

FIG. 1 shows an example communication network in which some example embodiments of the present disclosure may be implemented;

FIG. 2 shows a signaling chart illustrating a process for beam failure recovery for a serving cell according to some example embodiments of the present disclosure;

FIG. 3 shows a flowchart of a method implemented at a device in accordance with some example embodiments of the present disclosure;

FIG. 4 shows a flowchart of a method implemented at a device in accordance with some other example embodiments of the present disclosure;

FIG. 5 shows a simplified block diagram of an apparatus that is suitable for implementing some example embodiments of the present disclosure; and

FIG. 6 shows a block diagram of an example computer readable medium in accordance with some example embodiments of the present disclosure.

Throughout the drawings, the same or similar reference numerals represent the same or similar element.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitation as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

As used herein, the term “communication network” refers to a network that follows any suitable communication standards or protocols such as long term evolution (LTE), LTE-Advanced (LTE-A) and 5G NR, and employs any suitable communication technologies, including, for example, Multiple-Input Multiple-Output (MIMO), OFDM, time division multiplexing (TDM), frequency division multiplexing (FDM), code division multiplexing (CDM), Bluetooth, ZigBee, machine type communication (MTC), eMBB, mMTC and uRLLC technologies. For the purpose of discussion, in some embodiments, the LTE network, the LTE-A network, the 5G NR network or any combination thereof is taken as an example of the communication network.

As used herein, the term “network device” refers to any suitable device at a network side of a communication network. The network device may include any suitable device in an access network of the communication network, for example, including a base station (BS), a relay, an access point (AP), a node B (NodeB or NB), an evolved NodeB (eNodeB or eNB), a next generation NodeB (gNB), a Remote Radio Module (RRU), a radio header (RH), a remote radio head (RRH), a low power node such as a femto, a pico, Integrated Access Backhaul (IAB) node, and the like. For the purpose of discussion, in some embodiments, the eNB is taken as an example of the network device.

The network device may also include any suitable device in a core network, for example, including multi-standard radio (MSR) radio equipment such as MSR BSs, network controllers such as radio network controllers (RNCs) or base station controllers (BSCs), Multi-cell/multicast Coordination Entities (MCEs), Mobile Switching Centers (MSCs) and MMEs, Operation and Management (O&M) nodes, Operation Support System (OSS) nodes, Self-Organization Network (SON) nodes, positioning nodes, such as Enhanced Serving Mobile Location Centers (E-SMLCs), and/or Mobile Data Terminals (MDTs).

As used herein, the term “terminal device” refers to a device capable of, configured for, arranged for, and/or operable for communications with a network device or a further terminal device in a communication network. The communications may involve transmitting and/or receiving wireless signals using electromagnetic signals, radio waves, infrared signals, and/or other types of signals suitable for conveying information over air. In some embodiments, the terminal device may be configured to transmit and/or receive information without direct human interaction. For example, the terminal device may transmit information to the network device on predetermined schedules, when triggered by an internal or external event, or in response to requests from the network side.

Examples of the terminal device include, but are not limited to, user equipment (UE) such as smart phones, wireless-enabled tablet computers, laptop-embedded equipment (LEE), laptop-mounted equipment (LME), and/or wireless customer-premises equipment (CPE). For the purpose of discussion, in the following, some embodiments will be described with reference to UEs as examples of the terminal devices, and the terms “terminal device” and “user equipment” (UE) may be used interchangeably in the context of the present disclosure.

As used herein, the term “cell” refers to an area covered by radio signals transmitted by a network device. The terminal device within the cell may be served by the network device and access the communication network via the network device.

As used herein, the term “circuitry” may refer to one or more or all of the following:

(a) hardware-only circuit implementations (such as implementations in only analog and/or digital circuitry) and
(b) combinations of hardware circuits and software, such as (as applicable): (i) a combination of analog and/or digital hardware circuit(s) with software/firmware and (ii) any portions of hardware processor(s) with software (including digital signal processor(s)), software, and memory(ies) that work together to cause an apparatus, such as a mobile phone or server, to perform various functions) and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

As used herein, the singular forms “a”, “an”, and “the” are intended to include the plural forms as well, unless the context clearly indicates otherwise. The term “includes” and its variants are to be read as open terms that mean “includes, but is not limited to”. The term “based on” is to be read as “based at least in part on”. The term “one embodiment” and “an embodiment” are to be read as “at least one embodiment”. The term “another embodiment” is to be read as “at least one other embodiment”. Other definitions, explicit and implicit, may be included below.

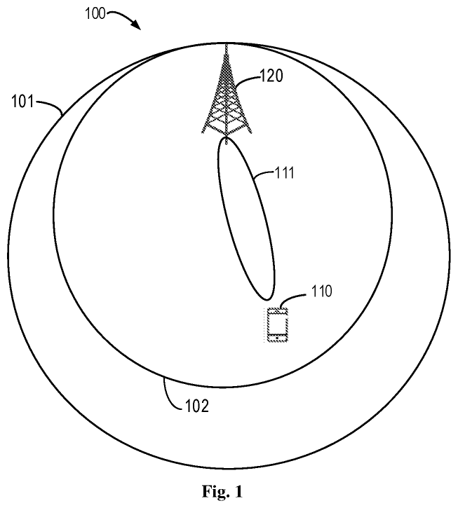

FIG. 1 shows an example communication network 100 in which embodiments of the present disclosure can be implemented. The network 100 includes a first device 110 and a second device 120 that can communicate with each other. In this example, the first device 110 is illustrated as a terminal device, and the second device 120 is illustrated as a network device serving the terminal device. The second device 120 may provide one or more serving cells 101, 102 to serve the first device 110. It is to be understood that the number of the first device, the second device and serving cells is only for the purpose of illustration without suggesting any limitations. The network 100 may include any suitable number of the first and second devices and serving cells adapted for implementing embodiments of the present disclosure. It is to be noted that the term “cell” and “serving cell” can be used interchangeably herein.

In the network 100, the second device 120 can communicate data and control information to the first device 110, and the first device 110 can also communication data and control information to the second device 120. A link from the second device 120 to the first device 110 is referred to as a downlink (DL) or a forward link, and a link from the first device 110 to the second device 120 is referred to as an uplink (UL) or a reverse link.

The communications in the network 100 may conform to any suitable standards including, but not limited to 5G New Radio (NR), Long Term Evolution (LTE), LTE-Evolution, LTE-Advanced (LTE-A), Wideband Code Division Multiple Access (WCDMA), Code Division Multiple Access (CDMA) and Global System for Mobile Communications (GSM) and the like. Furthermore, the communications may be performed according to any generation communication protocols either currently known or to be developed in the future. Examples of the communication protocols include, but not limited to, the first generation (1G), the second generation (2G), 2.5G, 2.75G, the third generation (3G), the fourth generation (4G), 4.5G, the fifth generation (5G) communication protocols.

CA can be supported in the network 100. In CA, two or more component carriers (CCs) are aggregated in order to support a broader bandwidth. In CA, the second device 120 may configure the first device 110 with a plurality of serving cells including one PCell 101 and at least one SCell 102. Although only one SCell 102 is shown in FIG. 1, the second device 120 may configure the first device 110 with a plurality of SCells. The first device 110 may be configured to perform BFR for any of configured SCells. The maximum number of SCells for which the first device 110 performs BFR may depend on a capability of the first device 110. It is also to be understood that the configuration of PCell 101 and SCell 102 shown in FIG. 1 is only for the purpose of illustration without suggesting any limitations. PCell 101 and SCell 102 may be in other configurations than that shown in FIG. 1.

In some example embodiments, the second device 120 is configured to implement beamforming technique and transmit signals to the first device 110 via a plurality of beams. Different beams may be configured for the PCell 101 and the SCell 102. For example, as shown in FIG. 1, a DL beam 111 is configured for the SCell 102. It is to be understood that more beams may be configured for the SCell 102. Although not shown, one or more beams may be configured for the PCell 101.

A beam failure may occur when quality of all or part of beams serving the first device 110 falls low enough. The beam failure may occur in any of the PCell 101 and the SCell 102. Upon detecting the beam failure, the first device 110 may initiate a BFR procedure to recover at least one beam or control channel link. To recover the beam, the first device 110 may transmit a beam failure recovery request indicating the beam failure to the second device 120. In addition, the first device 110 may also indicate a new potential beam to the second device 120. The new potential beam is also referred to as a candidate beam. As a response to the beam failure recovery request, the second device 120 may configure the first device 110 with a new control channel link. Then, the second device 120 communicates with the first device 110 by using the new control channel link.

For the purpose of identifying a candidate beam for recovery from the beam failure, the second device 120 may configure the first device 110 with a list of reference signals identifying the candidate beam.

The second device 120 may configure the reference signals on a per Bandwidth Part (BWP) basis. For example, if the first device 110 is configured with a plurality of BWPs in the SCell 102, the second device 120 configures the first device 110 with a respective list of reference signals identifying a candidate beam for each of the plurality of BWPs. It will be appreciated that in case where the first device 110 is configured with the plurality of BWPs in the SCell 102, only one of the BWPs may be active at a given time.

Because a list of reference signals identifying a candidate beam in an SCell is configured on a per BWP basis, the currently active BWP where a terminal device is operating during the beam failure detection may either not be configured with a list of reference signals identifying a candidate beam or the candidate beam is not visible. In this case, conventionally, the terminal device will report to a network device that there is no candidate beam identified for the SCell. Thus, the network device has no means to resolve the beam failure for the terminal device immediately, other than deactivating the SCell before Radio Resource Management (RRM) measurements are received over Radio Resource Control (RRC) in the SCell. Alternatively, the network device may keep the SCell active while waiting for the RRM measurements.

In order to at least in part solve above and other potential problems, example embodiments of the present disclosure provide a solution for BFR for a serving cell. In the solution, if a first device fails to detect a first candidate beam associated with a first BWP, the first device will switch from the first BWP to a second BWP. The second BWP is configured with at least one reference signal identifying a second candidate beam for BFR. If the first device detects the second candidate beam based on the at least one reference signal successfully, the first device will transmit information concerning the second candidate beam to a second device for BFR. Thus, the first device has more chances of indicating a candidate beam to the second device to recover the beam failure in the serving cell. In addition, the solution allows not to configure candidate beams for all the BWPs for BFR in a serving cell, which simplifies the network operation and configuration.

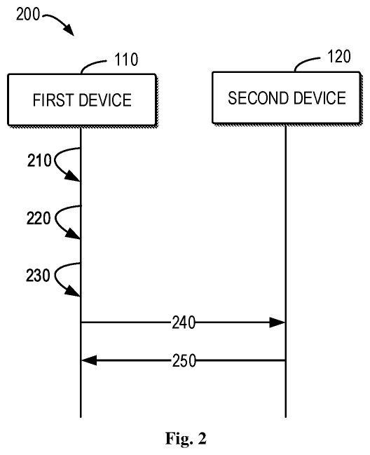

Reference is now made to FIG. 2, which shows a signaling chart illustrating a process 200 for BFR for a serving cell according to some example embodiments of the present disclosure. For the purpose of discussion, the process 200 will be described with reference to FIG. 1. The process 200 may involve the first device 110 and the second device 120 as illustrated in FIG. 1. Although the process 200 will be described in the communication network 100 of FIG. 1, this process may be likewise applied to other communication scenarios.

If the first device 110 detects a beam failure in a serving cell, the first device 110 detects 210 a first candidate beam associated with a first BWP. The first bandwidth part is active. In some embodiments, detecting the first candidate beam associated with the first BWP comprises determining whether the first BWP is configured with at least one reference signal identifying the first candidate beam.

In some embodiments, the serving cell may be the SCell 102 as shown in FIG. 1. In other embodiments, the serving cell may be the PCell 101 as shown in FIG. 1. Although the process 200 will be described in connection with BFR for an SCell (also referred to as SCell BFR), this process may be likewise applied to BFR for a PCell.

If the first device 110 fails to detect the first candidate beam, the first device 110 switches 220 from the first BWP to a second BWP in the serving cell. The second BWP is configured with at least one reference signal identifying a second candidate beam for recovery from the beam failure.

In some embodiments, at least one reference signal identifying a candidate beam for BFR comprises at least one of the following: a Channel State Information Reference Signal (CSI-RS), or Synchronization Signals (SS) and Physical Broadcast Channel (PBCH) Block (SSB). SSB may also be referred to as Synchronization Signals Block or SS/PBCH block.

In some embodiments, the second device 120 may not configure the first BWP with any reference signals identifying the first candidate beam for BFR. Thus, the first device 110 will fail to detect the first candidate beam.

In other embodiments, the second device 120 may configure the first BWP with at least one reference signal identifying the first candidate beam for BFR. In some embodiments, the second device 120 may configure a BWP (the first BWP or the second BWP) with at least one reference signal by using a BeamFailureRecoveryConfig information element (IE) as shown in Table 1.

TABLE 1
BeamFailureRecoveryConfig information element

```
-- ASN1START
-- TAG-BEAMFAILURERECOVERYCONFIG-START
BeamFailureRecoveryConfig ::=  SEQUENCE {
    rootSequenceIndex-BFR  INTEGER (0..137)
OPTIONAL, -- Need M
    rach-ConfigBFR  RACH-ConfigGeneric
OPTIONAL, -- Need M
    rsrp-ThresholdSSB  RSRP-Range
OPTIONAL, -- Need M
    candidateBeamRSList  SEQUENCE (SIZE(1..maxNrofCandidateBeams)) OF
PRACH-ResourceDedicatedBFR  OPTIONAL, -- Need M
    ssb-perRACH-Occasion  ENUMERATED {oneEighth, oneFourth, oneHalf, one,
two, four, eight, sixteen}
OPTIONAL, -- Need M
    ra-ssb-OccasionMaskIndex  INTEGER (0..15)
OPTIONAL, -- Need M
    recoverySearchSpaceId  SearchSpaceId
OPTIONAL, -- Need R
    ra-Prioritization  RA-Prioritization
OPTIONAL, -- Need R
    beamFailureRecoveryTimer  ENUMERATED {ms10, ms20, ms40, ms60, ms80,
ms100, ms150, ms200}
OPTIONAL, -- Need M
    ...,
    [[
    msg1-SubcarrierSpacing-v1530  SubcarrierSpacing
OPTIONAL -- Need M
    ]]
}
PRACH-ResourceDedicatedBFR ::=  CHOICE {
    ssb  BFR-SSB-Resource,
    csi-RS  BFR-CSIRS-Resource
}
BFR-SSB-Resource ::=  SEQUENCE {
    ssb  SSB-Index,
    ra-PreambleIndex  INTEGER (0..63),
    ...
}
BFR-CSIRS-Resource ::=  SEQUENCE {
    csi-RS  NZP-CSI-RS-ResourceId,
    ra-OccasionList  SEQUENCE
(SIZE(1..maxRA-OccasionsPerCSIRS)) OF INTEGER (0..maxRA-Occasions-1)
OPTIONAL,  -- Need R
    ra-PreambleIndex  INTEGER (0..63)
OPTIONAL,  -- Need R
    ...
}
-- TAG-BEAMFAILURERECOVERYCONFIG-STOP
-- ASN1STOP
```

In some embodiments, at least one reference signal identifying a candidate beam for BFR may be indicated by the “candidateBeamRSList” in Table 1.

In embodiments where the at least one reference signal comprises CSI-RS, the candidate beam associated with the CSI-RS may be identified by “NZP-CSI-RS-ResourceId” in Table 1. In embodiments where the at least one reference signal comprises SSB, the candidate beam associated with the SSB may be identified by “SSB-Index” in Table 1.

The second device 120 may configure the first device 110 with the reference signals on a per BWP basis. For example, the second device 120 may configure these reference signals to be within the linked DL BWP (i.e., within the DL BWP with the same bwp-Id) of the UL BWP for which the BeamFailureRecoveryConfig IE is provided.

In some embodiments, for SCell BFR, a maximum number of reference signals for identifying the candidate beam per BWP may be 64.

In some embodiments, for SCell BFR, the range of threshold for identifying a candidate beam may be based on the range indicated in “RSRP-Range” in Table 1.

In the embodiments where the second device 120 configures the first BWP with at least one reference signal identifying the first candidate beam for BFR, for the purpose of detecting the first candidate beam, the first device 110 may determine whether Reference Signal Received Power (RSRP) of the at least one reference signal is above the threshold indicated in “RSRP-Range” in Table 1. If no reference signal has a RSRP above the threshold, the first device 110 will fail to detect the first candidate beam. In some embodiments, the RSRP is either L1 RSRP or L3 filtered RSRP value. In other words, the fact that no reference signal has a RSRP above the threshold may result in a failure of detecting the first candidate beam. In addition, it should be understood that if the second device 120 does not configure the first BWP with the at least one reference signal identifying the first candidate beam for BFR, the failure of detecting the first candidate beam may occur.

In some embodiments, the second BWP comprises a preconfigured BWP. For example, the second BWP comprises a downlink BWP to be used upon activation of the serving cell. In such embodiments, the second BWP may be indicated by firstActiveDownlinkBWP-Id in an RRC configuration message from the second device 120.

In some other embodiments, the first device 110 may determine the second BWP based on a predefined criterion. For example, the first device 110 may determine whether a BWP is configured with at least one reference signal. If the BWP is configured with the at least one reference signal, the first device 110 determines the BWP as the second BWP and switches to the BWP. For example, the at least one reference signal may be SSB.

In still other embodiments, the second device 120 may configure the first device 110 with the second BWP. In such embodiments, the first device 110 may receive configuration information concerning the second BWP from the second device 120. For example, the first device 110 may receive configuration information in an RRC configuration message from the second device 120. Then, the first device 110 switches to the second BWP based on the configuration information.

With continued reference to FIG. 2, upon switching to the second BWP, the first device 110 detects 230 the second candidate beam based on the at least one reference signal configured for the second BWP. Similar to the detection of the first candidate beam, the first device 110 may determine whether an RSRP of the at least one reference signal configured for the second BWP is above the threshold indicated in “RSRP-Range” in Table 1. If the at least one reference signal configured for the second BWP has an RSRP above the threshold, the first device 110 will detect the second candidate beam successfully. On the other hand, if no reference signal configured for the second BWP has an RSRP above the threshold, the first device 110 will fail to detect the second candidate beam.

If the first device 110 detects the second candidate beam successfully, the first device 110 transmits 240 information concerning the second candidate beam to the second device 120 for BFR.

In some embodiments, the first device 110 may transmit the information concerning the second candidate beam together with an identifier of the serving cell so as to save signaling. Alternatively, the first device 110 may transmit the information concerning the second candidate beam and the identifier of the serving cell separately.

In some embodiments, the first device 110 may transmit an identifier of the second BWP to the second device 120. Upon receiving the identifier of the second BWP, the second device 120 may determine the second BWP based on the identifier and communicate with the first device 110 on the second BWP.

Upon receiving the information concerning the second candidate beam, the second device 120 communicates 250 with the first device 110 by using the second candidate beam.

According to embodiments of the present disclosure, if the first device 110 fails to detect the first candidate beam associated with the first BWP, the first device 110 will switch to the second BWP and detect the second candidate beam associated with the second BWP. In this way, the first device has more chances of indicating a candidate beam to the second device to recover the beam failure in the serving cell. In addition, embodiments of the present disclosure allow not to configure candidate beams for all the BWPs for BFR in the serving cell. Thus, operation and configuration of the network are simplified.

In some embodiments, the first device 110 may transmit an indication of the switching to the second device 120. For example, in embodiments where the second BWP is preconfigured or configured by the second device 120, the second device 120 knows the second BWP in advance. Thus, the first device 110 may transmit to the second device 120 the indication of the switching without the identifier of the second BWP. In this way, overhead in the air interface may be reduced.

In some embodiments, the indication of the switching may be a one bit indicator. The indicator is set to be a predefined value indicating the switching.

In some embodiments, the first device 110 may transmit the indication of the switching as well as the second candidate beam and identifier of the serving cell in a Medium Access Control control element (MAC CE).

In some embodiments, if the first device 110 detects the second candidate beam successfully, the first device 110 will transmit to the second device 120 the information concerning the second candidate beam without the indication of the switching. In such embodiments, the second device 120 may determine the BWP based on the information concerning the second candidate beam configured for the BWP.

On the other hand, if the first device 110 fails to detect the second candidate beam, the first device 110 may transmit to the second device 120 an indication of a failure of detecting a candidate beam without the information concerning the second candidate beam. Such indication may comprise an indication of no candidate available. In such embodiments, the first device 110 may transmit the indication of the failure of detecting the candidate beam together with the identifier of the serving cell so as to save signaling. In such embodiments, the first device 110 may transmit to the second device 120 the indication of the switching. Upon receiving the indication of the switching, for example, the second device 120 may reconfigure at least one reference signal identifying a candidate beam or deactivate the serving cell.

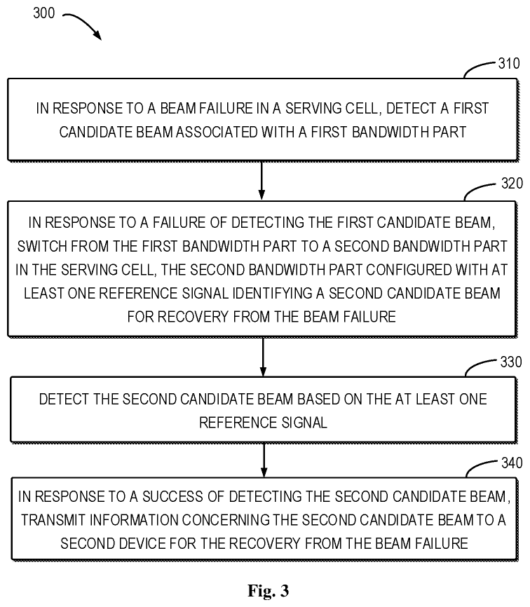

FIG. 3 shows a flowchart of an example method 300 implemented at a device in accordance with some example embodiments of the present disclosure. For the purpose of discussion, the method 300 will be described from the perspective of the first device 110 with reference to FIG. 1. It would be appreciated that the method 300 may also be implemented at the second device 120 in FIG. 1.

At block 310, in response to a beam failure in a serving cell, the first device 110 detects a first candidate beam associated with a first bandwidth part. The first bandwidth part is active.

At block 320, in response to a failure of detecting the first candidate beam, the first device 110 switches from the first bandwidth part to a second bandwidth part in the serving cell. The second bandwidth part is configured with at least one reference signal identifying a second candidate beam for recovery from the beam failure.

At block 330, the first device 110 detects the second candidate beam based on the at least one reference signal.

At block 340, in response to a success of detecting the second candidate beam, the first device 110 transmits information concerning the second candidate beam to the second device 120 for the recovery from the beam failure.

In some embodiments, the method 300 further comprises: in response to a failure of detecting the second candidate beam, transmitting an indication of a failure of detecting a candidate beam to the second device 120.

In some embodiments, the second bandwidth part comprises a downlink bandwidth part to be used upon activation of the serving cell.

In some embodiments, the first device 110 switches from the first bandwidth part to the second bandwidth part by: determining whether a bandwidth part for the first device 110 is configured with the at least one reference signal; and in response to a determination that the bandwidth part is configured with the at least one reference signal, switching to the bandwidth part.

In some embodiments, the method 300 further comprises transmitting an identifier of the second bandwidth part to the second device 120.

In some embodiments, the method 300 further comprises receiving configuration information concerning the second bandwidth part from the second device 120. The first device 110 switches from the first bandwidth part to the second bandwidth part by switching to the second bandwidth part based on the configuration information.

In some embodiments, the method 300 further comprises transmitting an indication of the switching to the second device 120.

In some embodiments, the first device 110 transmits the indication of the switching by transmitting the indication in response to a failure of detecting the second candidate beam.

In some embodiments, the first device 110 transmits the indication of the switching by transmitting the indication in a Medium Access Control control element.

In some embodiments, the at least one reference signal comprises at least one of the following: a Channel State Information Reference Signal, or Synchronization Signals and Physical Broadcast Channel Block.

In some embodiments, the first device 110 is a terminal device, and the second device 120 is a network device.

In some embodiments, the serving cell comprises a secondary cell.

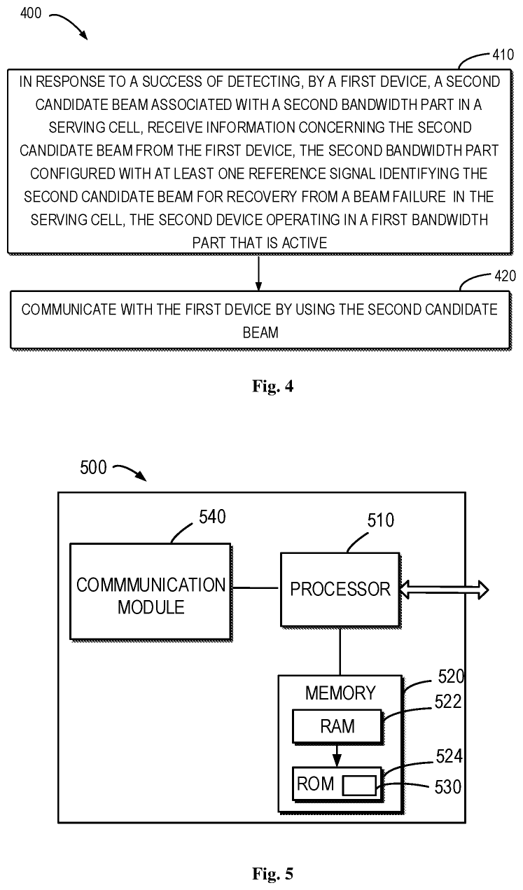

FIG. 4 shows a flowchart of an example method 400 implemented at a device in accordance with some example embodiments of the present disclosure. For the purpose of discussion, the method 400 will be described from the perspective of the second device 120 with reference to FIG. 1. It would be appreciated that the method 400 may also be implemented at the first device 110 in FIG. 1.

At block 410, in response to a success of detecting, by a first device, a second candidate beam associated with a second bandwidth part in a serving cell, the second device 120 receives information concerning the second candidate beam from the first device 110. The second bandwidth part is configured with at least one reference signal identifying the second candidate beam for recovery from a beam failure in the serving cell. The second device operates in a first bandwidth part that is active.

At block 420, the second device 120 communicates with the first device 110 by using the second candidate beam.

In some embodiments, the method 400 further comprises: in response to a failure of detecting the second candidate beam by the first device 110, receiving an indication of a failure of detecting a candidate beam from the first device 110.

In some embodiments, the second bandwidth part comprises a downlink bandwidth part to be used upon activation of the serving cell.

In some embodiments, the method 400 further comprises: determining the second bandwidth part based on the information concerning the second candidate beam; and communicating with the first device 110 on the second bandwidth part by using the second candidate beam.

In some embodiments, the method 400 further comprises: receiving an identifier of the second bandwidth part from the first device 110.

In some embodiments, the method 400 further comprises: transmitting configuration information concerning the second bandwidth part to the first device 110 so that the first device 110 switches from the first bandwidth part to the second bandwidth part based on the configuration information.

In some embodiments, the method 400 further comprises: receiving from the first device 110 an indication that the first device 110 switches from the first bandwidth part to the second bandwidth part.

In some embodiments, the second device 120 receives the indication by receiving the indication in response to a failure of detecting the second candidate beam by the first device 110

In some embodiments, the second device 120 receives the indication by receiving the indication in a Medium Access Control control element.

In some embodiments, the at least one reference signal comprises at least one of the following: a Channel State Information Reference Signal, or Synchronization Signals and Physical Broadcast Channel Block.

In some embodiments, the first device 110 is a terminal device, and the second device 120 is a network device.

In some embodiments, the serving cell comprises a secondary cell.

It shall be appreciated that descriptions of features with reference to FIGS. 1 to 2 also apply to the methods 300 and 400, and have the same effects. Thus, the details of the features are omitted.

In some example embodiments, an apparatus capable of performing any of the method 300 (for example, the first device 110) may comprise means for performing the respective steps of the method 300. The means may be implemented in any suitable form. For example, the means may be implemented in a circuitry or software module.

In some example embodiments, the apparatus comprises: in response to a beam failure in a serving cell, means for detecting, at a first device, a first candidate beam associated with a first bandwidth part, the first bandwidth part being active; in response to a failure of detecting the first candidate beam, means for switching from the first bandwidth part to a second bandwidth part in the serving cell, the second bandwidth part configured with at least one reference signal identifying a second candidate beam for recovery from the beam failure; means for detecting the second candidate beam based on the at least one reference signal; and in response to a success of detecting the second candidate beam, means for transmitting information concerning the second candidate beam to a second device for the recovery from the beam failure.

In some embodiments, the apparatus further comprises: in response to a failure of detecting the second candidate beam, means for transmitting an indication of a failure of detecting a candidate beam to the second device 120.

In some embodiments, the second bandwidth part comprises a downlink bandwidth part to be used upon activation of the serving cell.

In some embodiments, means for switching from the first bandwidth part to the second bandwidth part comprises: means for determining whether a bandwidth part for the first device 110 is configured with the at least one reference signal; and in response to a determination that the bandwidth part is configured with the at least one reference signal, means for switching to the bandwidth part.

In some embodiments, the apparatus further comprises means for transmitting an identifier of the second bandwidth part to the second device 120.

In some embodiments, the apparatus further comprises means for receiving configuration information concerning the second bandwidth part from the second device 120. In such embodiments, means for switching from the first bandwidth part to the second bandwidth part comprises means for switching to the second bandwidth part based on the configuration information.

In some embodiments, the apparatus further comprises means for transmitting an indication of the switching to the second device 120.

In some embodiments, means for transmitting the indication of the switching comprises means for transmitting the indication in response to a failure of detecting the second candidate beam.

In some embodiments, means for transmitting the indication of the switching comprises means for transmitting the indication in a Medium Access Control control element.

In some embodiments, the at least one reference signal comprises at least one of the following: a Channel State Information Reference Signal, or Synchronization Signals and Physical Broadcast Channel Block.

In some embodiments, the first device 110 is a terminal device, and the second device 120 is a network device.

In some embodiments, the serving cell comprises a secondary cell.

In some example embodiments, an apparatus capable of performing any of the method 400 (for example, the second device 120) may comprise means for performing the respective steps of the method 400. The means may be implemented in any suitable form. For example, the means may be implemented in a circuitry or software module.

In some example embodiments, the apparatus comprises: in response to a success of detecting, by a first device, a second candidate beam associated with a second bandwidth part in a serving cell, means for receiving, at a second device and from the first device, information concerning the second candidate beam, the second bandwidth part configured with at least one reference signal identifying the second candidate beam for recovery from a beam failure in the serving cell, the second device operating in a first bandwidth part that is active; and means for communicating with the first device by using the second candidate beam.

In some embodiments, the apparatus further comprises: in response to a failure of detecting the second candidate beam by the first device 110, means for receiving an indication of a failure of detecting a candidate beam from the first device 110.

In some embodiments, the second bandwidth part comprises a downlink bandwidth part to be used upon activation of the serving cell.

In some embodiments, the apparatus further comprises: means for determining the second bandwidth part based on the information concerning the second candidate beam; and means for communicating with the first device 110 on the second bandwidth part by using the second candidate beam.

In some embodiments, the apparatus further comprises: means for receiving an identifier of the second bandwidth part from the first device 110.

In some embodiments, the apparatus further comprises: means for transmitting configuration information concerning the second bandwidth part to the first device 110 so that the first device 110 switches from the first bandwidth part to the second bandwidth part based on the configuration information.

In some embodiments, the apparatus further comprises: means for receiving from the first device 110 an indication that the first device 110 switches from the first bandwidth part to the second bandwidth part.

In some embodiments, means for receiving the indication comprises: means for receiving the indication in response to a failure of detecting the second candidate beam by the first device 110

In some embodiments, means for receiving the indication comprises: means for receiving the indication in a Medium Access Control control element.

In some embodiments, the at least one reference signal comprises at least one of the following: a Channel State Information Reference Signal, or Synchronization Signals and Physical Broadcast Channel Block.

In some embodiments, the first device 110 is a terminal device, and the second device 120 is a network device.

In some embodiments, the serving cell comprises a secondary cell.

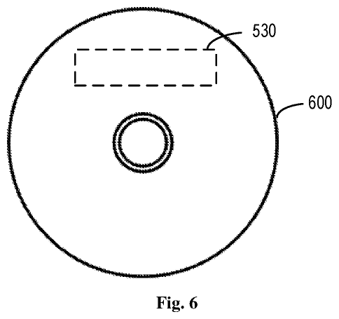

FIG. 5 is a simplified block diagram of a device 500 that is suitable for implementing embodiments of the present disclosure. The device 500 may be provided to implement the communication device, for example the first device 110, the first device 110 or the second device 120 as shown in FIG. 1. As shown, the device 500 includes one or more processors 510, one or more memories 520 coupled to the processor 510, and one or more communication modules 540 coupled to the processor 510.

The communication module 540 is for bidirectional communications. The communication module 540 has at least one antenna to facilitate communication. The communication interface may represent any interface that is necessary for communication with other network elements.

The processor 510 may be of any type suitable to the local technical network and may include one or more of the following: general purpose computers, special purpose computers, microprocessors, digital signal processors (DSPs) and processors based on multicore processor architecture, as non-limiting examples. The device 500 may have multiple processors, such as an application specific integrated circuit chip that is slaved in time to a clock which synchronizes the main processor.

The memory 520 may include one or more non-volatile memories and one or more volatile memories. Examples of the non-volatile memories include, but are not limited to, a Read Only Memory (ROM) 524, an electrically programmable read only memory (EPROM), a flash memory, a hard disk, a compact disc (CD), a digital video disk (DVD), and other magnetic storage and/or optical storage. Examples of the volatile memories include, but are not limited to, a random access memory (RAM) 522 and other volatile memories that will not last in the power-down duration.

A computer program 530 includes computer executable instructions that are executed by the associated processor 510. The program 530 may be stored in the ROM 524. The processor 510 may perform any suitable actions and processing by loading the program 530 into the RAM 522.

The embodiments of the present disclosure may be implemented by means of the program 530 so that the device 500 may perform any process of the disclosure as discussed with reference to FIGS. 2 to 4. The embodiments of the present disclosure may also be implemented by hardware or by a combination of software and hardware.

In some example embodiments, the program 530 may be tangibly contained in a computer readable medium which may be included in the device 500 (such as in the memory 520) or other storage devices that are accessible by the device 500. The device 500 may load the program 530 from the computer readable medium to the RAM 522 for execution. The computer readable medium may include any types of tangible non-volatile storage, such as ROM, EPROM, a flash memory, a hard disk, CD, DVD, and the like. FIG. 6 shows an example of the computer readable medium 600 in form of CD or DVD. The computer readable medium has the program 530 stored thereon.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representations, it is to be understood that the block, apparatus, system, technique or method described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the methods 300 and 400 as described above with reference to FIGS. 3 and 4. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

In the context of the present disclosure, the computer program codes or related data may be carried by any suitable carrier to enable the device, apparatus or processor to perform various processes and operations as described above. Examples of the carrier include a signal, computer readable medium, and the like.

The computer readable medium may be a computer readable signal medium or a computer readable storage medium. A computer readable medium may include but not limited to an electronic, magnetic, optical, electromagnetic, infrared, or semiconductor system, apparatus, or device, or any suitable combination of the foregoing. More specific examples of the computer readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in languages specific to structural features and/or methodological acts, it is to be understood that the present disclosure defined in the appended claims is not necessarily limited to the specific features or acts described above. Rather, the specific features and acts described above are disclosed as example forms of implementing the claims.

1.-32. (canceled)

33. An apparatus, comprising:
at least one processor; and
at least one memory including computer program code;
the at least one memory and the computer program code configured to, with the at least one processor, cause the apparatus at least to:
detect, based on a beam failure in a serving cell, a first candidate beam associated with a first bandwidth part, the first bandwidth part being active;
switch, based on a failure of detecting the first candidate beam, from the first bandwidth part to a second bandwidth part in the serving cell, the second bandwidth part configured with at least one reference signal identifying a second candidate beam for recovery from the beam failure;
detect the second candidate beam based on the at least one reference signal; and
transmit, based on a success of detecting the second candidate beam, information concerning the second candidate beam to a network device for the recovery from the beam failure.

34. The apparatus of claim 33, wherein the at least one memory and computer program code are further configured to, with the at least one processor, cause the apparatus at least to:
transmit, based on a failure of detecting the second candidate beam, an indication of a failure of detecting a candidate beam to the network device.

35. The apparatus of claim 33, wherein the second bandwidth part comprises a downlink bandwidth part to be used upon activation of the serving cell.

36. The apparatus of claim 33, wherein the at least one memory and computer program code are further configured to, with the at least one processor, cause the apparatus at least to:
transmit an identifier of the second bandwidth part to the network device.

37. The apparatus of claim 33, wherein the at least one memory and computer program code are further configured to, with the at least one processor, cause the apparatus at least to:
receive configuration information concerning the second bandwidth part from the network device; and
switch to the second bandwidth part based on the configuration information.

38. The apparatus of claim 33, wherein the at least one memory and computer program code are further configured to, with the at least one processor, cause the apparatus at least to:
transmit an indication of the switching to the network device.

39. The apparatus of claim 38, wherein the at least one memory and computer program code configured to transmit an indication of the switching are further configured to, with the at least one processor, cause the apparatus at least to:
transmit the indication in a first medium access control control element.

40. The apparatus of claim 33, wherein the at least one memory and computer program code are further configured to, with the at least one processor, cause the apparatus at least to:
transmit to the network device information concerning the second candidate beam in a second medium access control control element.

41. The apparatus of claim 33, wherein the at least one reference signal comprises at least one of the following:
a channel state information reference signal, or
a synchronization signal block.

42. An apparatus, comprising:
at least one processor; and
at least one memory including computer program code;
the at least one memory and the computer program code configured to, with the at least one processor, cause the apparatus at least to:
receive information concerning a second candidate beam from a first device, based on a success of detecting, by the first device, the second candidate beam associated with a second bandwidth part in a serving cell, the second bandwidth part configured with at least one reference signal identifying the second candidate beam for recovery from a beam failure in the serving cell, the apparatus operating in a first bandwidth part that is active; and
communicate with the first device by using the second candidate beam.

43. The apparatus of claim 42, wherein the at least one memory and computer program code are further configured to, with the at least one processor, cause the apparatus at least to:
receive, from the first device, an indication of a failure of detecting a candidate beam by the first device.

44. The apparatus of claim 42, wherein the second bandwidth part comprises a downlink bandwidth part to be used upon activation of the serving cell.

45. The apparatus of claim 42, wherein the at least one memory and computer program code are further configured to, with the at least one processor, cause the apparatus at least to:
determine the second bandwidth part based on the information concerning the second candidate beam; and
communicate with the first device on the second bandwidth part by using the second candidate beam.

46. The apparatus of claim 42, wherein the at least one memory and computer program code are further configured to, with the at least one processor, cause the apparatus at least to:
receive an identifier of the second bandwidth part from the first device.

47. The apparatus of claim 42, wherein the at least one memory and computer program code are further configured to, with the at least one processor, cause the apparatus at least to:
transmit configuration information concerning the second bandwidth part to the first device so that the first device switches from the first bandwidth part to the second bandwidth part based on the configuration information.

48. The apparatus of claim 42, wherein the at least one memory and computer program code are further configured to, with the at least one processor, cause the apparatus at least to:
receive, from the first device, an indication that the first device switches from the first bandwidth part to the second bandwidth part.

49. The apparatus of claim 48, wherein the at least one memory and computer program code are further configured to, with the at least one processor, cause the apparatus at least to:
receive the indication by a failure of detecting the second candidate beam by the first device.

50. The apparatus of claim 42, wherein the at least one reference signal comprises at least one of the following:
a channel state information reference signal, or
a synchronization signal block.

51. The apparatus of claim 42, wherein the serving cell comprises a secondary cell.

52. A method, comprising:
detecting, at a first device and based on a beam failure in a serving cell, a first candidate beam associated with a first bandwidth part, the first bandwidth part being active;
switching, based on a failure of detecting the first candidate beam, from the first bandwidth part to a second bandwidth part in the serving cell, the second bandwidth part configured with at least one reference signal identifying a second candidate beam for recovery from the beam failure;
detecting the second candidate beam based on the at least one reference signal; and
transmitting, based on a success of detecting the second candidate beam, information concerning the second candidate beam to a second device for the recovery from the beam failure.
